(19) United States
(12) Patent Application Publication
(10) Pub. No.: US 2010/0192644 A1
(43) Pub. Date: Aug. 5, 2010

(54) OUTBOARD MOTOR LOCK ASSEMBLY

(76) Inventor: Donald R. Frantz, New Berlin, WI (US)

Correspondence Address: JOSEPH S. HEINO, ESQ.;DAVIS & KUELTHAU, S.C., 111 E. KILBOURN, SUITE 1400, MILWAUKEE, WI, 53202-6613, US

(21) Appl. No.: 11/916,287

(22) PCT Filed: Jun. 2, 2005
(86) PCT No.: PCT/US05/19426

§ 371 Date: Dec. 3, 2007

(51) Int. Cl. E05B 65/12

(52) U.S. Cl. 70/174

(57) ABSTRACT

An outboard motor lock assembly (10) has a longitudinally extending base (20) having a longitudinally-extending slot (28) defined within the base (20). The base (20) is functionally adapted to overlay the lever-like head portions (8) of the clamping screws (18) that are used with the motor supports (6), when the head portions (8) are aligned in a co-linear fashion. In that position, the base (20) slides over the lever-like head portions (8) via the slot (28), one end (26) of the slot (28) being open and the opposite end of the slot (28) being closed to allow for this movement. A transversely disposed lock cylinder (45) is slidingly attached to the base (20) at the open end (26) of the slot (28). The lock cylinder (45) includes a latch (44) that is engageable with a latch “keeper” (35) that is also situated at the open end (26) of the slot (28). When the lock cylinder latch (44) is secured to the latch keeper (35), the lock cylinder (45) effectively blocks the slot opening (26) and the base (20) is unable to be slid along the head portions (8) of the clamping screws (18), thus locking the base (20) atop the clamping screws (18).

### FIELD OF THE INVENTION

The present invention relates generally to locks and other security devices that use locks. More specifically, it relates to a lock assembly that is used to secure an outboard motor to the transom of the motorboat. It also relates to such an outboard motor lock assembly that is unitary in construction such that the assembly is easy to use and eliminates the risk of loss of component parts.

### BACKGROUND OF THE INVENTION

The use of outboard motors with power boats typically requires that the motor be attached and secured to the transom, or rear wall, of the motorboat. Such outboard motors often utilize a frame that hangs on the transom and is then fixedly secured to the transom by a pair of screw-driven clamps that are part of the frame. The clamping screws include handle portions that can be rotated by hand to tighten the clamping screws and secure the outboard motor to the transom. These handle portions can be inadvertently rotated to the point that the outboard motor is no longer securely attached to the transom. Another unfortunate reality concerning motorboats is that, although motors are typically heavy, the motor is nevertheless vulnerable to theft since it can be relatively quickly and easily detached from the boat by simple rotation and un-tighten of the clamping screws and removal of the motor from the transom. Accordingly, a number of devices exist in the prior art for attempting to prevent or frustrate this type of inadvertent or intentional activity. Each of those devices, however, require the use of multiple parts that are not connected together except when secured to the clamping screws of the motor. Prior to use, the multiple parts may become separated from one another or even lost, thus frustrating proper or intended use of the device.

### SUMMARY OF THE INVENTION

Accordingly, what is needed is a unitary, or single piece, locking device or lock assembly for securely and inexpensively locking an outboard boat motor to the boat that it is attached to. The present invention provides a unitary assembly that, when used properly, helps to prevent inadvertent detachment or intentional theft of the outboard boat motor at all times during which the assembly is used. The unitary construction also prevents loss of component part of the lock assembly which would otherwise frustrate the intended purpose of the lock assembly. The present invention provides for a unique locking assembly having a longitudinally extending base having a longitudinally extending slot defined within the base. The base is functionally adapted to overlay the lever-like head portions of the clamping screws that are used with the motor supports, when the head portions are aligned in a co-linear fashion. In that position, the base slides over the lever-like head portions via the slot, one end of the slot being open and the opposite end of the slot being closed to allow for this movement. A transversely disposed lock cylinder is slidingly attached to the base at the open end of the slot. The lock cylinder includes a latch that is engageable with a latch “keeper” that is also situated at the open end of the slot. When the lock cylinder latch is secured to the latch keeper, the lock cylinder effectively blocks the slot opening and the base is unable to be slid along the head portions of the clamping screws, thus locking the base atop the clamping screws. The foregoing and other features of the assembly of the present invention will be apparent from the detailed description that follows.

### BRIEF DESCRIPTION OF THE DRAWINGS

FIG. 1 is a front, top and left side perspective view of an outboard motor lock assembly constructed in accordance with the present invention and showing it as it is used with an outboard boat motor that is mounted to a boat, the assembly shown in the attached or “locked” position.

FIG. 2 is a front, top and left side perspective view of the outboard motor lock assembly of the present invention as it is used with an outboard boat motor that is mounted to a boat, the assembly shown in the detached or “unlocked” position.

FIG. 3 is an enlarged rear, top and left side perspective view of the lock assembly illustrated in FIGS. 1 and 2 and showing the assembly, though detached, as it would be in the “locked” position.

FIG. 4 is the same view of the detached lock assembly shown in FIG. 3 but showing the assembly in the “unlocked” position.

FIG. 5 is another view of the lock assembly shown in FIGS. 3 and 4 and showing the lock sub-assembly in an “exploded” view.

FIG. 6 is a further enlarged, exploded and partially-sectioned front, top and left side perspective view of the receiving end of the assembly of the present invention.

FIG. 7 is a still further enlarged and partially-sectioned front, top and left side perspective view of the receiving end of the assembly of the present invention and showing the assembly in the “locked” position.

### DETAILED DESCRIPTION OF THE INVENTION

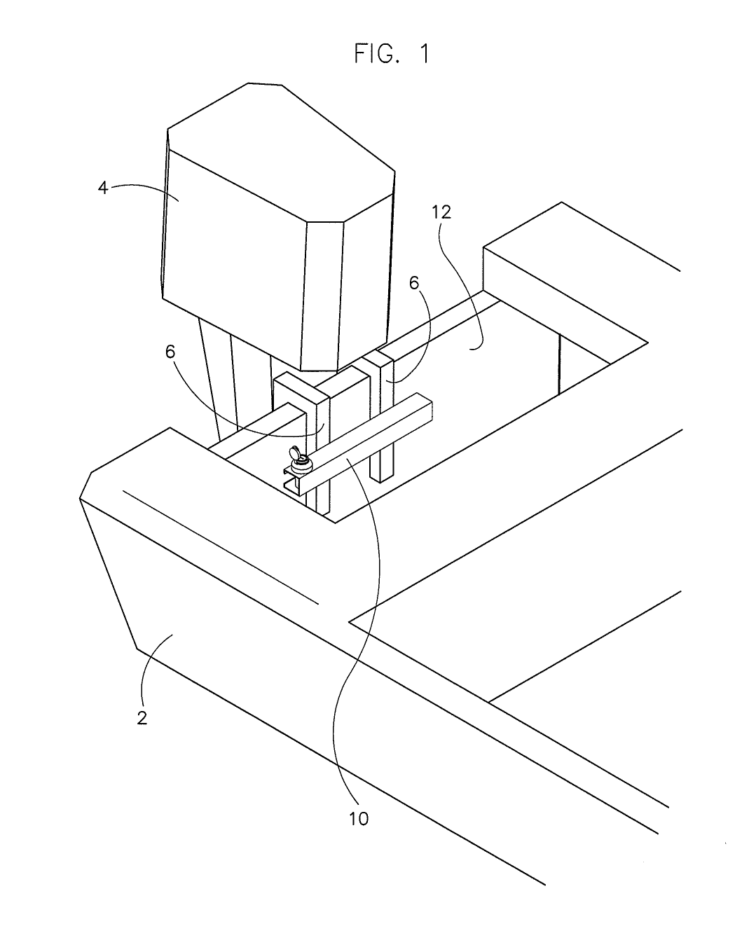

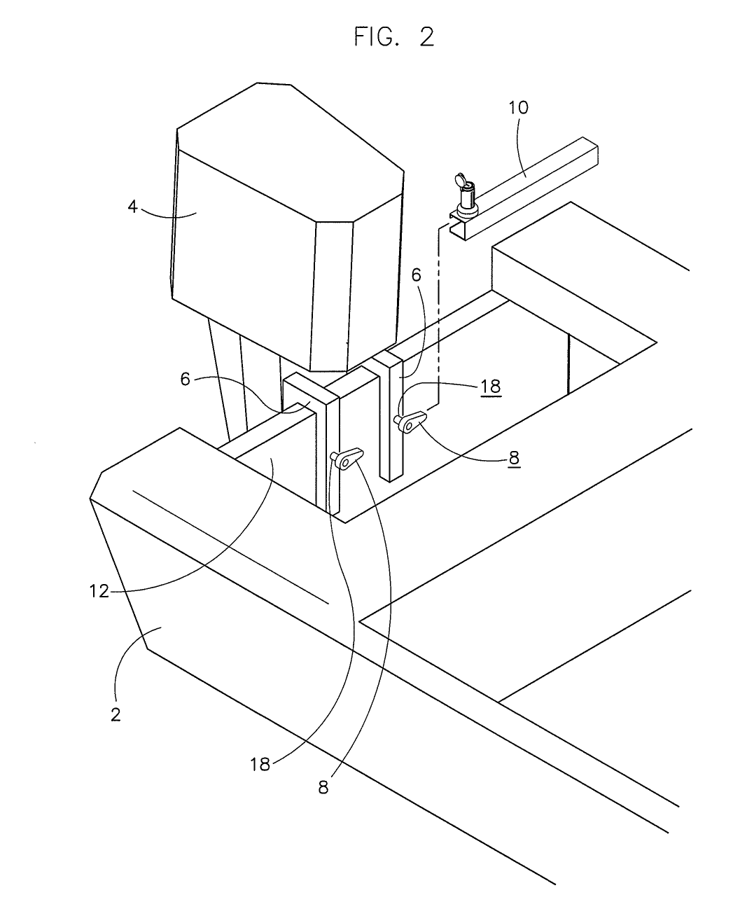

Referring now to the drawings in detail, wherein like numbered elements correspond to like elements throughout, FIG. 1 is a perspective view showing the outboard motor lock assembly, generally identified 10, constructed in accordance with the present invention. As shown, the lock assembly 10 is shown as it would be attached to the head portions 8 of the clamping screws 18 of the motor supports 6 of the outboard motor 4 when the outboard motor 4 is secured to the transom 12 of a boat 2. See also FIG. 2. It is to be understood that the precise type of boat 2 or boat motor 4 to which the assembly 10 of the present invention applies is not a limitation of this invention. The only practical limitation is that the head portions 8 of the clamping screws 18 preferably be of the type that are generally lever-shaped. That is, each head portion 8 rotates about a central axis and has a lever portion that extends outwardly from that central axis to provide a force moment or torque to the clamping screw 18 for tightening or un-tightening the screw 18 from the motor supports 6. Rotation of the head portion 8 rotates the clamping screw 18 in a direction that drives a pad (not shown) towards or away from the transom 12 such that the clamping screw 18 effectively “clamps” the motor 6 to the transom 12.

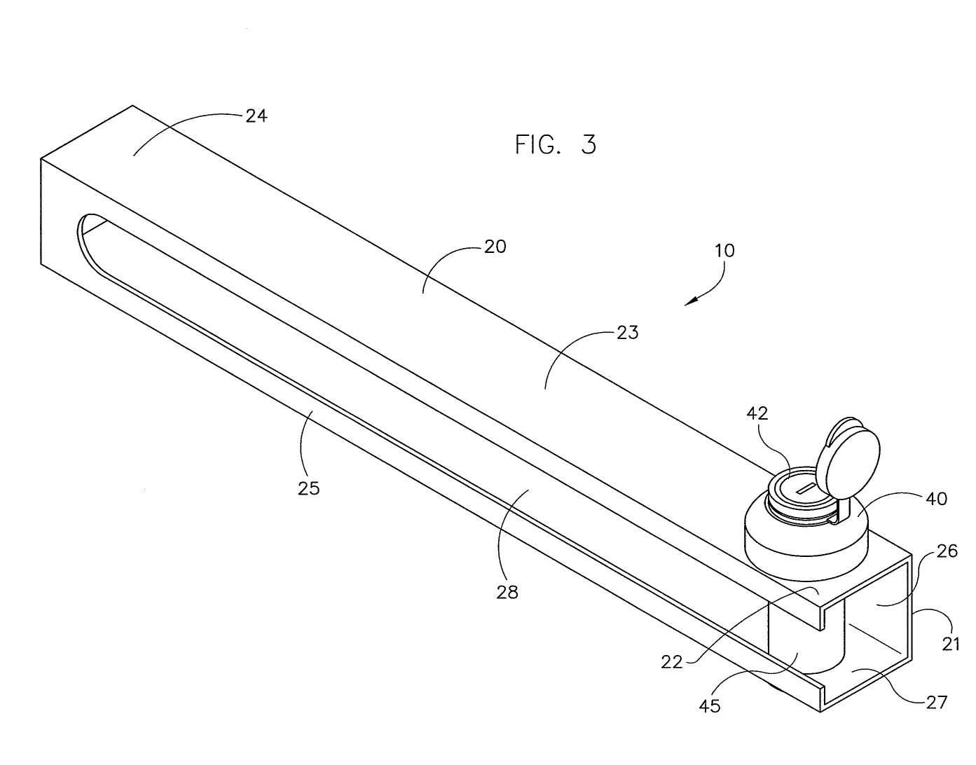

Referring now to FIG. 3, an enlarged rear view of the assembly 10 of the present invention is illustrated. This view illustrates the assembly 10 shown as it would be when detached from the clamping screws 18 of the motor supports 6. The assembly 10 includes a longitudinally-extending and generally square-profiled tubular base 20. Although this square tubular profile is disclosed as a preferred embodiment of this assembly 10, such is not a limitation of the present invention. The base 20 could be alternatively configured and still function as intended. As shown in the preferred embodiment, the base 20 has a first end 22 and a second end 24. Extending between the first end 22 and the second end 24 of the base 20 is a longitudinally-extending and generally planar front face 21, a longitudinally-extending and generally planar top face 23, a longitudinally-extending and generally planar back face 25 and a longitudinally-extending and generally planar bottom face 27. Disposed at the first end 22 of the base 20 is a first end opening 26, the base 20 being tubular and generally hollow in cross sectional profile. Defined within the back face 25 of the base 20 is a longitudinally-extending slot 28 that has an open end that is coterminous with the first end opening 26 of the base 20. The slot 28 is closed at the second end 24 of the base 20. The width of the slot 28 is less than the width of the head portion 8 of the clamping screws 18 for reasons that will be apparent later in this detailed description.

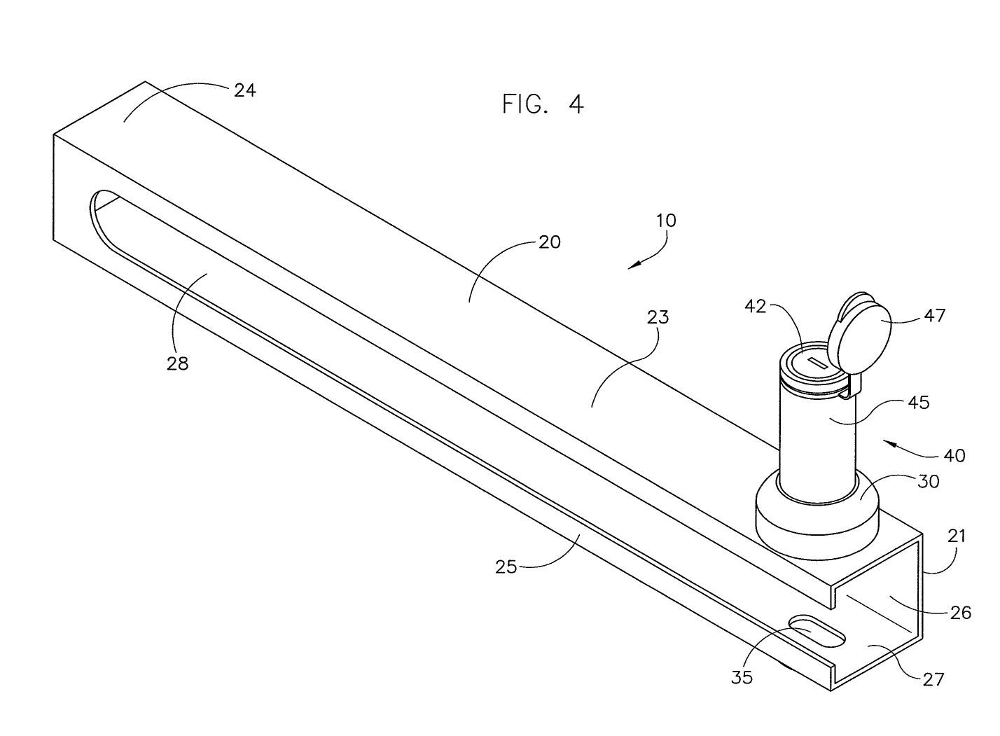

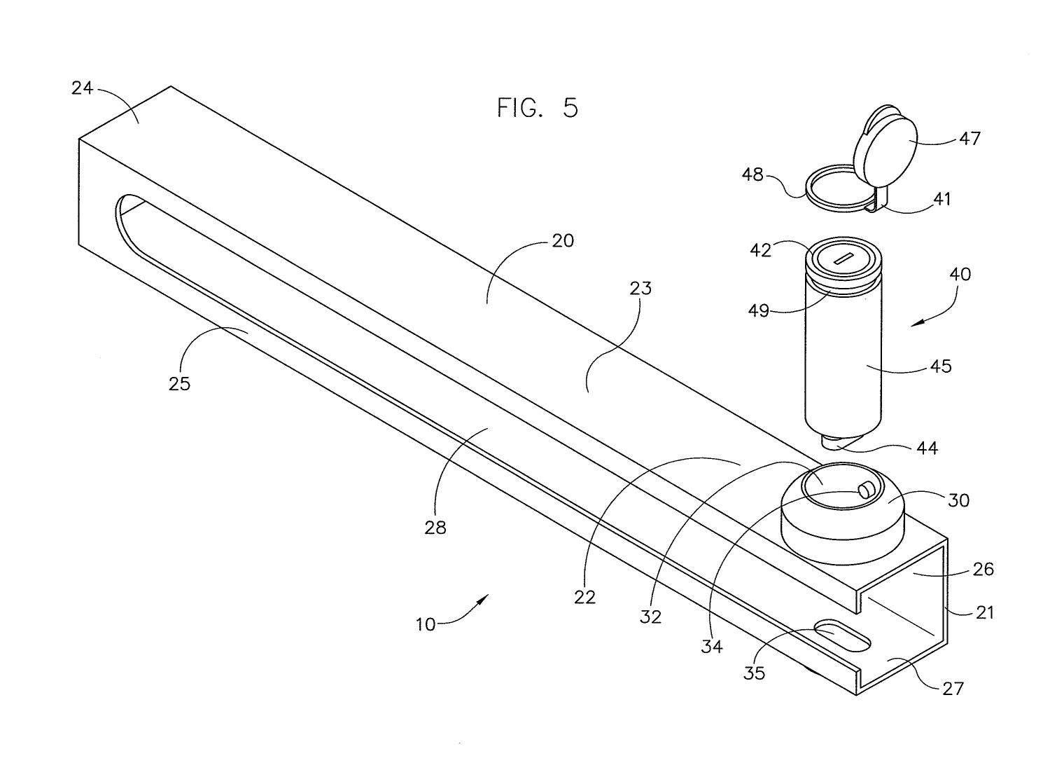

Also shown in FIG. 3, is a lock sub-assembly 40 for the assembly 10. Referring now FIG. 4, it will be seen that a portion of the lock sub-assembly 40 is able to be pulled upwardly and generally outwardly from the base 20. Referring now to FIG. 5, which is a view similar to those shown in FIGS. 3 and 4 and showing the lock sub-assembly 40 in an exploded view, it will be seen more clearly that the lock sub-assembly 40 includes a lock cylinder 45 that is slidingly movable within an aperture 32 defined within a lock receiver 30. It is to be understood that the lock cylinder receiver 30 may be secured to or otherwise attached to the top face 23 of the base 20 in any number of ways and such is not a limitation of the present invention. It is also to be understood that the aperture 32 defined within the lock cylinder receiver 30 extends fully through the top face 23 of the base 20 as well. In this fashion, the lock cylinder 45 is able to pass through and extend through the top face 23 of the base 20 as well.

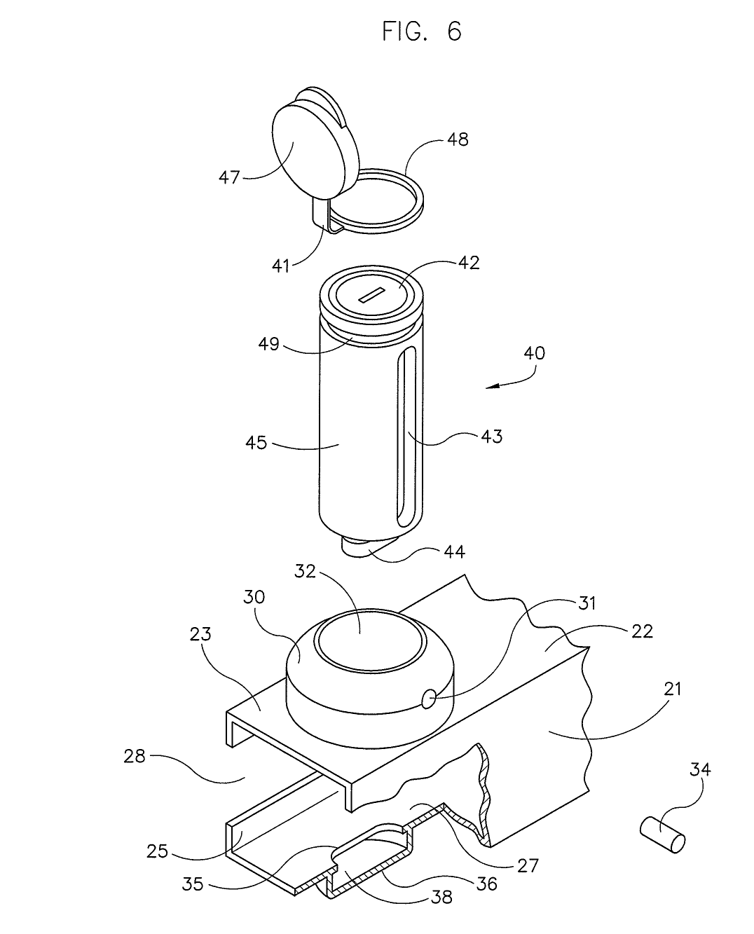

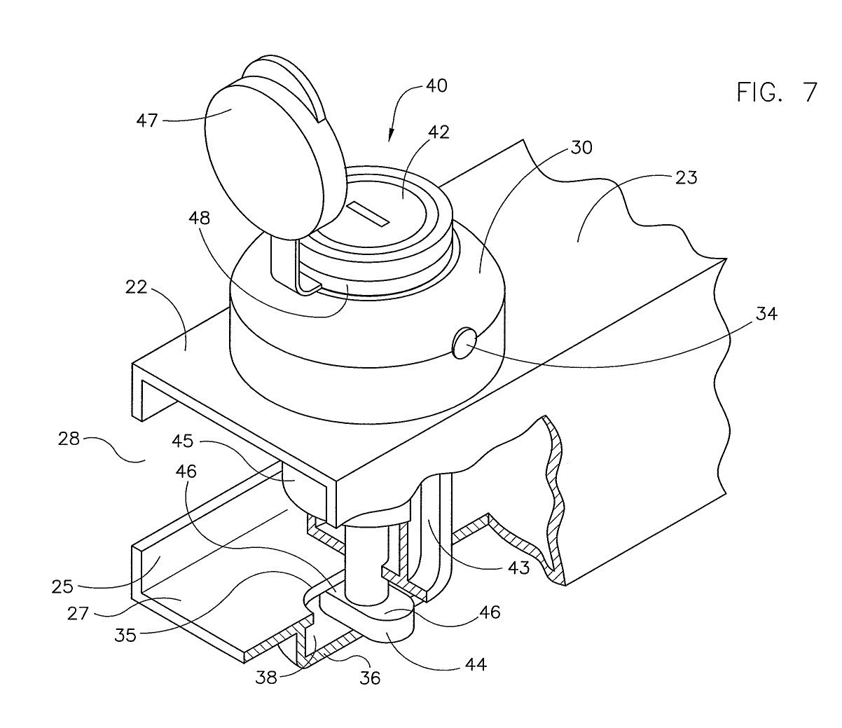

The lock cylinder 45 includes a key receiving end 42. The key receiving end 42 further includes a cap assembly 41 having a ring 48 and a cap 47. The ring 48 of the cap assembly 41 is receivable within the ring-receiving groove 49 that is defined within the lock cylinder 45. The lock cylinder receiver 30 also includes a transversely-disposed pinhole 31 defined within a portion of it, the pinhole 31 being functionally adapted to receive and frictionally keep a pin 34 within it. See FIG. 6. In this fashion, the lock cylinder 45, when received within the lock cylinder receiver 30, is able to be “captured” within the lock cylinder receiver 30. That is, its removal from the lock cylinder receiver 30 is prevented by virtue of the pin 34 that is placed within the hole 31, the pin 34 being receivable within a slot 43 that is defined within the sidewall of the lock cylinder 45. As shown in FIGS. 6 and 7, it will be seen that the bottom-most portion of the lock cylinder 45 includes a latch 44, the latch 44 including at least one latch shoulder 46. As shown in this preferred embodiment, a pair of opposing latch shoulders 46 are provided. Such is not, however, a limitation of the assembly 10 of the present invention. Note also that the latch 44 is generally elongate in its plan profile. The shape of the latch 44 is also not a limitation of the present invention. The latch 44 could be alternatively configured and still come within the scope of the claims herein.

It will also be seen that the bottom face 27 of the base 20 of the preferred embodiment includes a slot 35 that is defined within it. The slot 35 is generally elongate in shape and generally assumes the transverse or plan profile of the latch 44, the latch 44 slightly smaller in dimension than the slot 35 such that it is receivable through the slot 35. Immediately below the slot 35 is a keeper space 38 that is slightly larger than the slot 35. The bottom-most portion of the keeper space 38 is also framed by a slot cover 36, the slot cover 36 being a part of and being formed within the bottom face 27 to prevent access to and tampering with the latch 44 when the latch 44 is located within the keeper space 38. As shown in FIG. 7, the placement of the latch 44 in a transfer position relative to the latch slot 35 effectively secures and locks the latch 44 within the latch space 38, thereby preventing upward slideable movement of the lock cylinder 45 relative to the base 20. In this fashion, items, such as the head portions 8 of the clamping screws 18 as previously described are captured within the base 20 and the base 20 is prevented from slideable movement relative to the head portions 8.

In application, the user of the assembly 10 first pulls the lock cylinder 45 upwardly from the lock cylinder receiver 30 to clear a pathway into the tubular base 20. With the head portions 8 of the clamping screws 18 placed in a generally linear relationship as shown in FIG. 2, or in a position facing toward one another or other like relation, the user slides the base 20 along the head portions 8 of the clamping screws 18 by means of the first end opening 26 of the base 20. As the head portions 8 move through the slot 28, they are captured within the base 20 due to the fact that the width of the slot 28 is smaller in physical dimension than is the width of either head portion 8. With the head portions 8 in position, the lock cylinder 45 can then be slid downwardly into the top face 23 of the base 20. In this position, the latch 44 is received through the latch slot 35 that is defined within the bottom face 27 of the base 20. The latch 44 is further received within a space 38 that is defined by a latch cover 36 and the latch slot 35. The latch cover 36 is provided to prevent access to the latch 44 at any time during use of the assembly 10. Rotation of a key (not shown) within the key receiver 42, rotates the latch 44 about 90° and into a position that is transverse to the latch slot 35. In this position, the lock cylinder 45 is unable to be pulled upwardly through the lock cylinder receiver 30. With the key removed from the key receiver 42, the cap 47 is snapped into place over the key receiver 42 until detachment of the assembly 10 is desired or required by the user. To remove the assembly 10 from the head portions 8 of the clamping screws, the reverse of this above-described process is required.

Additional advantages and modifications will readily occur to those skilled in the art. Therefore, the invention in its broader aspects is not limited to the specific details disclosed and described herein. Accordingly, various modifications may be made without departing from the spirit or scope of the general inventive concept disclosed herein.

What is claimed is:

1. An outboard motor lock assembly (10) for use with a boat (2) and outboard motor (4), said outboard motor (4) including a motor support (6) and clamping screws (18), the clamping screws (18) each having a head portion (8) for securing the outboard motor (4) to the transom (12) of the boat (2), comprising:
a base (20), said base (20) comprising a longitudinally-extending tubular member having a top face (23), a back face (25) and a bottom face (27),
a longitudinally-extending slot (28) defined within the back face (25) of the base (20), said slot (28) having an opening (26) for receiving the head portion (8) of one or more clamping screws (18) therewithin, and
a lock sub-assembly (40) that is integral to the base (20) for providing a barrier at the opening (26) of the slot (28),
wherein the head portion (8) of the one or more clamping screws (18) are prevented from removal from the base (20).

2. The lock assembly (10) of claim 1 wherein the lock sub-assembly (40) includes a lock cylinder (45) that is slidingly movable between the top face (25) and the bottom face (27) of the base (20).

3. The lock assembly (10) of claim 2 wherein the lock sub-assembly (40) further includes a lock cylinder (45) having a latch (44) and a latch-receiving slot (35) defined within the bottom face (27) of the base (20).

4. The lock assembly (10) of claim 3 wherein the lock sub-assembly further includes a lock receiver (30) that is secured within the top face (25) of the base (20) and the lock cylinder (45) moves through an aperture (32) that is defined within the lock receiver (30).

5. The lock assembly (10) of claim 4 wherein the movement of the lock cylinder (45) within the aperture (32) of the lock receiver (30) is limited by virtue of a slot (43) defined within the sidewall of the lock cylinder (45) and a pin (34) that passes through the lock receiver (30).

6. The lock assembly (10) of claim 5 wherein the latch (44) of the lock cylinder (45) includes at least one latch shoulder (46), the latch shoulder (46) being receivable within the latch-receiving slot (35).

7. The lock assembly (10) of claim 6 wherein the latch-receiving slot (35) further includes a latch space (38) formed between the bottom face (27) of the base member (20) and a slot cover (36) wherein access to the latch (44) is prevented when the latch (44) is in a “locked” position.

8. An outboard motor lock assembly (10) for covering and securing the head portion (8) of one or more clamping screws (18) that are use with a boat (2) for securing an outboard motor (4) to the transom (12) of the boat (2), comprising:
a base (20), said base (20) comprising a longitudinally-extending and square-profiled tubular member having a longitudinally-extending and planar top face (23), a longitudinally-extending and planar back face (25) and a longitudinally-extending and planar bottom face (27),
a longitudinally-extending slot (28) defined within the back face (25) of the base (20), said slot (28) having an opening (26) for receiving the head portion (8) of the one or more clamping screws (18) within the slot (28), and
a lock sub-assembly (40) that is integrally-formed as part of the base (20) for providing a barrier at the opening (26) of the slot (28) to prevent removal of the head portion (8) of the one or more clamping screws (18) from the base (20) and to prevent access to the head portion (8).

9. The lock assembly (10) of claim 8 wherein the lock sub-assembly (40) includes a lock cylinder (45) that is slidingly movable between the top face (25) and the bottom face (27) of the base (20).

10. The lock assembly (10) of claim 9 wherein the lock sub-assembly (40) further includes a lock cylinder (45) having a latch (44) and a latch-receiving slot (35) defined within the bottom face (27) of the base (20).

11. The lock assembly (10) of claim 10 wherein the lock sub-assembly further includes a lock receiver (30) that is secured within the top face (25) of the base (20) and the lock cylinder (45) moves through an aperture (32) that is defined within the lock receiver (30).

12. The lock assembly (10) of claim 11 wherein the movement of the lock cylinder (45) within the aperture (32) of the lock receiver (30) is limited by virtue of a slot (43) defined within the sidewall of the lock cylinder (45) and a pin (34) that passes through the lock receiver (30).

13. The lock assembly (10) of claim 12 wherein the latch (44) of the lock cylinder (45) includes at least one latch shoulder (46), the latch shoulder (46) being receivable within the latch-receiving slot (35).

14. The lock assembly (10) of claim 13 wherein the latch-receiving slot (35) further includes a latch space (38) formed between the bottom face (27) of the base member (20) and a slot cover (36) wherein access to the latch (44) is prevented when the latch (44) is in a “locked” position.
